(19) United States
(12) Patent Application Publication
(10) Pub. No.: US 2016/0142681 A1
(43) Pub. Date: May 19, 2016

(54) SURVEILLANCE CAMERA AND FOCUS CONTROL METHOD THEREOF

(71) Applicant: IDIS CO., LTD., Daejeon-si (KR)

(72) Inventors: Dong Sang YU, Icheon-si (KR); Hyun Bin KIM, Seongnam-si (KR)

(73) Assignee: IDIS CO., LTD., Daejeon-si (KR)

(21) Appl. No.: 14/609,834

(22) Filed: Jan. 30, 2015

(30) Foreign Application Priority Data
Nov. 19, 2014 (KR) 10-2014-0161843

(51) Int. Cl. H04N 7/18; H04N 5/33; G02B 5/20

(52) U.S. Cl. CPC H04N 7/183; G02B 5/208; H04N 5/33

(57) ABSTRACT

Provided is a surveillance camera comprising: an image analyzer configured to analyze whether a captured image is a visible light image or an infrared image; and a focus controller configured to adjust a focus to a refractive index of infrared rays or visible lights according to an analytic result obtained by the image analyzer.

### CROSS-REFERENCE TO RELATED APPLICATION(S)

This application claims priority from Korean Patent Application No. 10-2014-0161843, filed Nov. 19, 2014, in the Korean Intellectual Property Office, the entire disclosure of which is incorporated herein by reference for all purposes.

### BACKGROUND

1. Field

The following description relates to a surveillance camera and, in particular, to a surveillance camera including an Infrared Ray (IR) cut filter.

2. Description of the Related Art

In general, a surveillance camera operates in a day/night mode. The surveillance camera uses an Infrared Ray (IR) cut filter to receive only lights within the visible range in the day mode and receive both of lights within the visible range and lights within the infrared range in the night mode. In addition, visible lights and infrared rays have a different refractive index, so that a focus is controlled differently according to whether the surveillance camera is the day/night mode.

Further, the surveillance camera uses an illumination sensor to determine an imaging mode. That is, the surveillance camera determines an imaging mode based on an illumination value sensed by the illumination sensor. However, if an area whose illumination is sensed by the illumination sensor of the surveillance camera is different from an actual imaging area of the surveillance camera, focus distortion may occur due to a difference in refractive indexes of visible lights and infrared rays.

### SUMMARY

The following description relates to a surveillance camera capable of controlling a focus according to an illumination environment of an actually imaging area, and a focus control method thereof.

In one general aspect, there is provided a surveillance camera capable of controlling a focus based on an actually captured image, the surveillance camera including: an image analyzer configured to analyze whether a captured image is a visible light image or an infrared image; and a focus controller configured to adjust a focus to a refractive index of infrared rays or visible lights according to an analytic result obtained by the image analyzer.

The image analyzer may be further configured to analyze the captured image in a case where an Infrared Ray (IR) cut filter is deactivated.

The surveillance camera may further include a filter controller configured to activate or deactivate the IR cut filter according to an illumination value sensed by an illumination sensor or brightness of the captured image. The surveillance camera may further include a lights controller configured to activate or deactivate an illumination element according to the illumination value sensed by the illumination sensor or the brightness of the captured image. The surveillance camera may further include a filter controller configured to activate the IR cut filter in response to the analytic result showing that the captured image is an infrared image, while deactivating the IR cut filter in response to the analytic result showing that the captured image is a visible light image.

In another general aspect, there is provided a focus control method including: analyzing whether a captured image is a visible light image or an infrared image; and adjusting a focus to a refractive index of visible lights or infrared rays according to the analytic result.

The analyzing may include analyzing the captured image in a case where an Infrared Ray (IR) cut filter is deactivated.

The focus control method may further include activating or deactivating the IR cut filter according to an illumination value sensed by an illumination sensor or brightness of the captured image. The focus control method may further include activating or deactivating illumination according to an illumination value sensed by an illumination sensor or brightness of the captured image. The focus control method may further include: activating the IR cut filter in response to an analytic result showing that the captured image is an infrared image; and deactivating the IR cut filter in response to an analytic result showing that the captured image is a visible light image.

Other features and aspects may be apparent from the following detailed description, the drawings, and the claims.

### BRIEF DESCRIPTION OF THE DRAWINGS

FIG. 1 is a block diagram illustrating a surveillance camera according to an exemplary embodiment.

FIG. 2 is a flowchart illustrating a method for removing an Infrared Ray (IR) cut filter according to an exemplary embodiment.

FIG. 3 is a flowchart illustrating a focus control method according to an exemplary embodiment.

FIG. 4 is a flowchart illustrating a focus control method according to another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

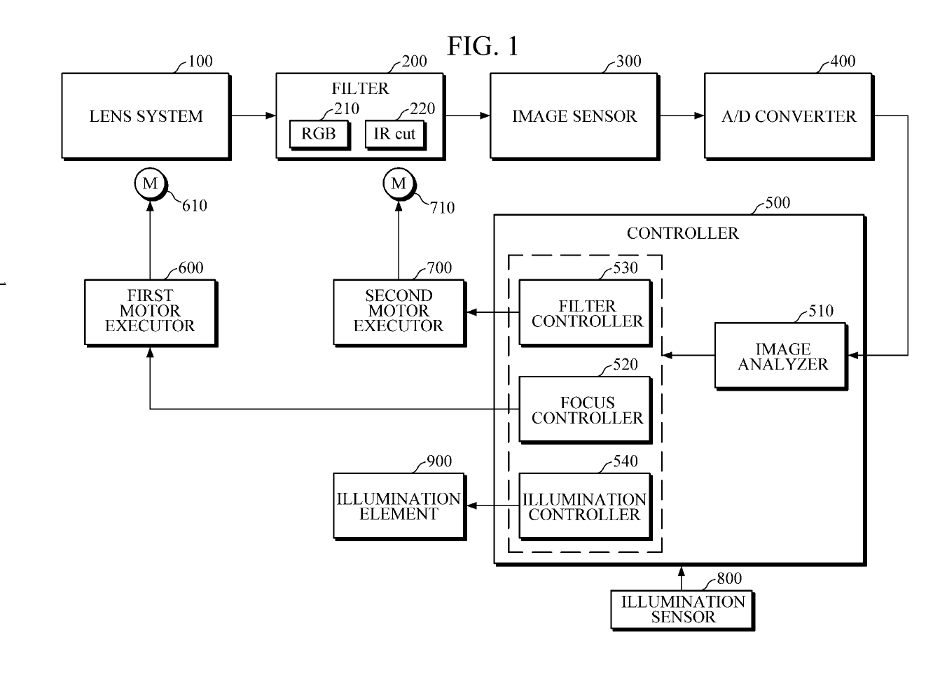

FIG. 1 is a block diagram illustrating a surveillance camera according to an exemplary embodiment of the present invention. As illustrated in FIG. 1, a surveillance camera may include a lens system 100, a filter 200, an image sensor 300, an analog/digital (A/D) converter 400, and a controller 500. The lens system consist of one or more lens. The filter 200 may include an RGB filter 210 for primary colors and an Infrared Ray (IR) cut filter 220.

The IR cut filter 220 presents the image sensor 300 from responding to infrared rays. The image sensor 300 may be a Charge Coupled Device (CCD) sensor and include a pixel array and a photoelectric converter. The pixel array accumulates charge responsive to the light from the lens system 100, and the photoelectric converts the charge accumulated in the pixel array. The A/D converter 400 converts an electronic analog signal into a digital signal. A captured image of a frame, which has been converted into a digital signal, may be stored in a buffer memory.

The controller 500 may include an image signal processor and/or a microcomputer. As illustrated in FIG. 1, the controller 500 may include an image analyzer 510 and a focus controller 520. The image analyzer 510 may be an image signal processor. The image analyzer 510 analyzes a captured image to determine whether the captured image is a visible light image or an infrared image. In addition, the image analyzer 510 may analyze brightness of a captured image.

The focus controller 520 may control a position of a focus lens by controlling the first motor executor 600 to execute the first motor 610, which is a focal motor. Based on the analytic result obtained by the image analyzer 510, the focus controller 520 may determine whether the captured image is a visible image or an infrared image. According to the analytic result obtained by the image analyzer 510, the focus controller 520 may moves a position of the focus lens in accordance with a refractive index of the focus lens. Focus information on the focus lens' refractive index of visible light and refractive index of infrared rays may have been stored in a memory in advance. Thus, the focus controller 520 may control a position of the focus lens with reference to the focus information stored in the memory.

Only when the IR cut filter 220 is inactive, the image analyzer 510 may analyze whether a captured image is a visible light image or an infrared image. If an imaging mode of a surveillance camera is changed from a day mode to a night mode, the IR cut filter 220 became inactivated. However, even when the surveillance camera operates in the night mode, the day mode, not the night mode, may be suitable for the lighting environment of the imaging area because artificial lights are used in the night. Thus, if the IR cut filter 220 becomes inactivated as the imaging mode of the surveillance camera is changed from the day mode to the night mode, the image analyzer 510 analyzes whether a captured image is a visible light image or an infrared image.

According to another aspect, the controller 500 may further include a filter controller 530. According to an exemplary embodiment, the filter controller 530 may activate or inactivate the IR cut filter 220 according to an illumination value sensed by an illumination sensor of the surveillance camera. That is, if an illumination value sensed by the illumination sensor 800 is equal to or greater than a reference value, the filter controller 530 activates the IR cut filter 220. Alternatively, if the illumination value sensed by the illumination sensor 800 is smaller than the reference value, the filter controller 530 deactivates the IR cut filter 220. According to another exemplary embodiment, the filter controller 530 activates the IR cut filter 220 in a case where a captured image is an infrared image, while deactivating the IR cut filter 220 in a case where the captured image is a visible light image.

The activated state of the IR cut filter 220 may indicates a case in which the IR cut filter 220 is arranged between the lens system 100 and the image sensor 300. The inactivated state of the IR cut filter 220 may indicate a case where the IR cut filter 220 is removed from between the lens system 110 and the image sensor 300. In the latter case, the IR cut filter 220 may be replaced by a transparent dummy glass. Thus, by controlling the second motor executor 700 to execute the second motor 710, the filter controller 530 may allow the IR cut filter 220 to be arranged between the lens system 100 and the image sensor 300 or may allow a dummy glass, instead of the IR cut filter 220, to be arranged between the lens system 100 and the image sensor 300.

According to another aspect, the controller 500 may further include an illumination element 900 and an illumination controller 540. The illumination element 900 may be an infrared illumination element. The illumination controller 540 activates or deactivates the illumination element 900. Specifically, if it is determined to be the night, the illumination controller 540 activates infrared rays so as to provide more illumination to an area where illumination is insufficient. According to an exemplary embodiment, the illumination controller 540 activates or deactivates the illumination element 900 according to an illumination value sensed by the illumination sensor 800. That is, if an illumination value sensed by the illumination sensor 800 is equal to or greater than a reference value, the illumination controller 540 activates the illumination element 900. Alternatively, if the illumination value is smaller than the reference value, the illumination controller 540 deactivates the illumination element 900. According to another exemplary embodiment, the illumination controller 530 activates or deactivates the illumination element 900 in accordance with activation or deactivation of the IR cut filter 220. That is, when the IR cut filter 220 is activated, the illumination controller 530 activates the illumination element 900. Alternatively, when the IR cut filter 220 is deactivated, the illumination controller 530 deactivates the illumination element 900.

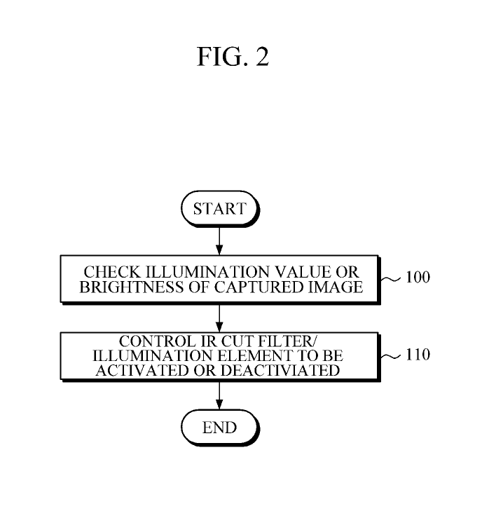

FIG. 2 is a flowchart illustrating a method for controlling an IR cut filter according to an exemplary embodiment. In 100, the controller 500 checks an illumination value or brightness of a captured image. The illumination value is obtained by an illumination sensor 800, and illumination information of the captured image may be obtained by analyzing the captured image. In 200, according to the illumination value or brightness of the captured image, the controller 500 may control the IR cut filter 220 to be activated or deactivated. As described above, by controlling the second motor executor 710 to execute the second motor 710, the controller 500 may allow the IR cut filter 220 to be arranged between the lens system 100 and the image sensor 300 to activate the IR cut filter 220, or may allow a dummy glass to replace the IR cut filter 220, arranged between the lens system 100 and the image sensor 300, to deactivate the IR cut filter 220.

In 200, the controller 500 may activate or deactivate the illumination element 900 along with the IR cut filter 200 according to the illumination value or brightness of the captured image. That is, if the illumination value is equal to or greater than a reference value, the controller 500 activates both of the IR cut filter 200 and the illumination element 900. Alternatively, if the illumination value is smaller than the reference value, the controller 500 deactivates both of the IR cut filter 220 and the illumination element 900.

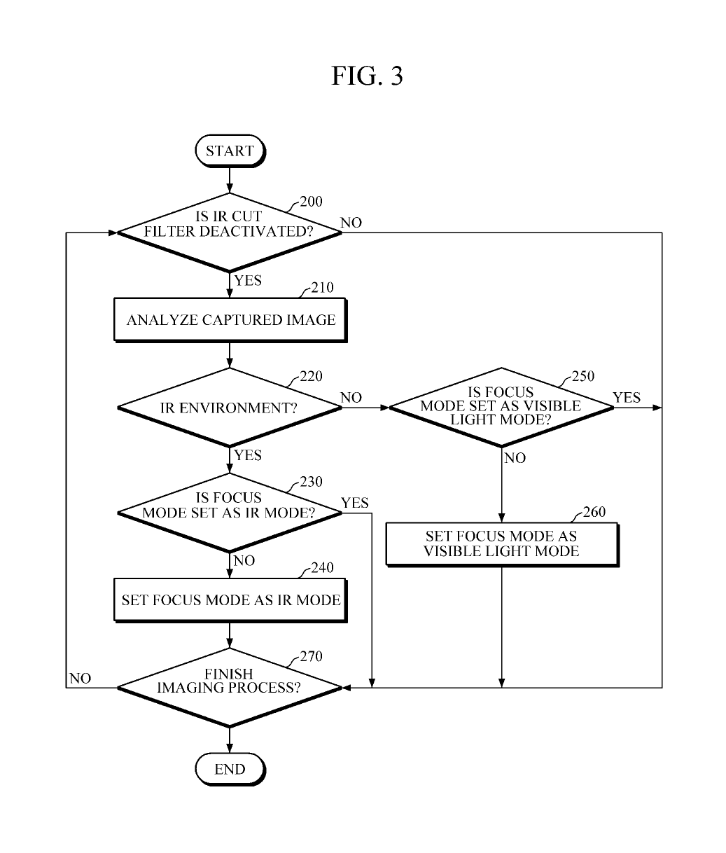

FIG. 3 is a flowchart illustrating a focus control method according to an exemplary embodiment. In 200, the controller 500 determines whether the IR cut filter 220 is activated or inactivated. State information may be stored in a memory, and the controller 500 may refer the state information to determine whether the IR cut filter 220 is activated or inactivated. When the IR cut filter 220 is inactivated, the controller 500 analyzes a received captured image in 210. According to an exemplary embodiment, the controller 500 may analyze spectroscopic characteristics of the captured image, and operation 100 may be omitted. That is, operation 200 may be performed regardless of whether the IR cut filter 200 is activated or not.

In 220, the controller 500 determines whether an imaging environment is an infrared (IR) environment, based on the analysis result of the captured image. That is, the controller 500 determines whether the captured image is an infrared image. In response to a determination made in 220 that the imaging environment is an IR environment, the controller 500 determines whether the focus mode is set as an infrared mode in 230. If the focus mode is set a as a visible light mode, the controller 500 changes the visible light mode to an infrared mode in 240; that is, the controller 500 adjusts the focus to a refractive index of infrared rays. In response to a determination made in 220 that the imaging environment is a visible light environment, the controller 500 determines whether the focus mode is set as a visible light mode in 250. If the focus mode is set as an infrared mode, the controller 500 changes the infrared mode to a visible light mode in 260; that is, the controller 500 adjusts the focus to a refractive index of visible lights. Then, the above operations are performed repeatedly until the imaging process is finished in 270.

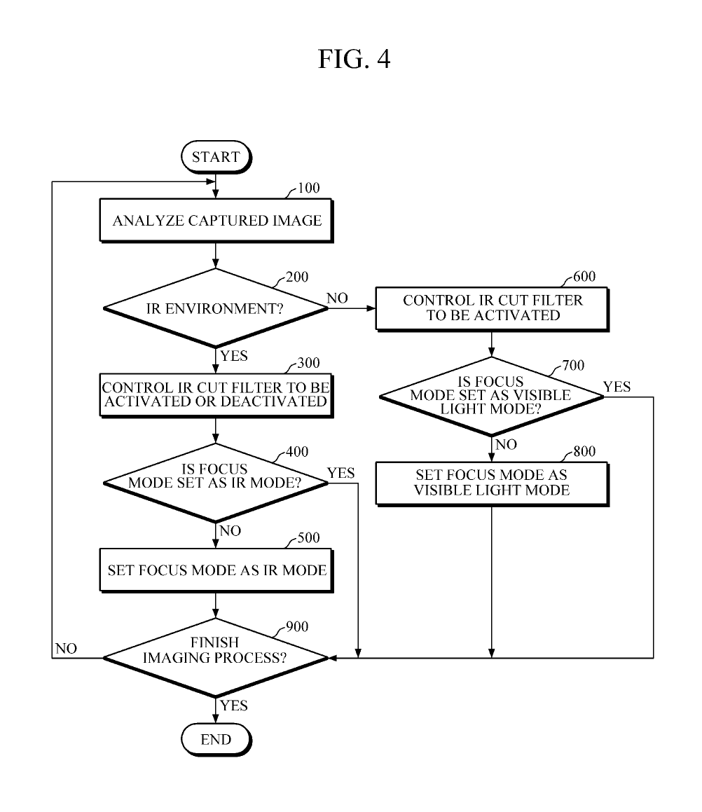

FIG. 4 is a flowchart illustrating a focus control method according to another exemplary embodiment. In 100, the controller 500 analyzes a received captured image. According to an exemplary embodiment, the controller 500 may analyze spectroscopic characteristics of the captured image. In 200, based on an analytic result of the captured image, the controller 500 determines whether an imaging environment is an IR environment. That is, the controller 500 determines whether the captured image is an infrared image or not. In response to a determination made in 200 that the imaging environment is an IR environment, the controller 500 controls the IR cut filter 200 to be deactivated in 300. Specifically, the controller 500 controls the IR cut filter 200 in an activated state to be deactivated. In 400, the controller 500 determines whether a focus mode is set as an infrared mode. If the focus mode is not set as an infrared mode, the controller 500 controls the focus mode to be set as the infrared mode in 500; that is, the controller 500 adjusts the focus to a refractive index of infrared rays. In response to a determination made in 200 that the imaging environment is a visible light environment, the controller 500 controls the IR cut filter 200 to be activated in 600; that is, the controller 500 controls the IR cut filter 200 in a deactivated state to be activated. In 700, the controller 500 determines whether the focus mode is set as a visible light mode. If the focus mode is not set as the visible light mode, the controller 500 controls the focus mode to be set as the visible light mode in 880; that is the controller 500 adjusts the focus to an refractive index of visible lights. The above operations are performed repeatedly until the imaging process ends in 900.

Although not illustrated, the controller 500 may activate the illumination element 900 in response to a determination in 200 that the imaging environment is an IR environment. That is, the controller 500 may activate the IR cut filter 220 and the illumination element 900 at the same time.

The present disclosure may control a focus according to an illumination environment of the actual imaging area, thereby preventing focus distortion.

In addition, the present invention activates or deactivates an IR cut filter based on an actual captured image, so that the IR cut filter may be used more appropriately.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A surveillance camera capable of controlling a focus based on an actually captured image, the surveillance camera comprising:
an image analyzer configured to analyze whether a captured image is a visible light image or an infrared image; and
a focus controller configured to adjust a focus to a refractive index of infrared rays or visible lights according to an analytic result obtained by the image analyzer.

2. The surveillance camera of claim 1, wherein the image analyzer is further configured to analyze the captured image in a case where an Infrared Ray (IR) cut filter is deactivated.

3. The surveillance camera of claim 2, further comprising:
a filter controller configured to activate or deactivate the IR cut filter according to an illumination value sensed by an illumination sensor or brightness of the captured image.

4. The surveillance camera of claim 3, further comprising:
a lights controller configured to activate or deactivate an illumination element according to the illumination value sensed by the illumination sensor or the brightness of the captured image.

5. The surveillance camera of claim 1, further comprising:
a filter controller configured to activate the IR cut filter in response to the analytic result showing that the captured image is an infrared image, while deactivating the IR cut filter in response to the analytic result showing that the captured image is a visible light image.

6. A focus control method comprising:
analyzing whether a captured image is a visible light image or an infrared image; and
adjusting a focus to a refractive index of visible lights or infrared rays according to the analytic result.

7. The focus control method of claim 6, wherein the analyzing comprises analyzing the captured image in a case where an Infrared Ray (IR) cut filter is deactivated.

8. The focus control method of claim 7, further comprising:
activating or deactivating the IR cut filter according to an illumination value sensed by an illumination sensor or brightness of the captured image.

9. The focus control method of claim 7, further comprising:
activating or deactivating an illumination element according to an illumination value sensed by an illumination sensor or brightness of the captured image.

10. The focus control method of claim 6, further comprising:
activating the IR cut filter in response to an analytic result showing that the captured image is an infrared image; and
deactivating the IR cut filter in response to an analytic result showing that the captured image is a visible light image.
